(19) United States
(12) Patent Application Publication
(10) Pub. No.: US 2026/0275204 A1
(43) Pub. Date: Sep. 17, 2026

(54) STEAM CRACKING OF NON-HYDROPROCESSED LIQUID HYDROCARBONS

(71) Applicant: Dow Global Technologies LLC, Midland, MI (US)

(72) Inventors: Georgios Bellos, Terneuzen (NL); Henk Hagen, Terneuzen (NL); Hangyao Wang, Pearland, TX (US)

(21) Appl. No.: 19/473,175

(22) PCT Filed: Apr. 26, 2023
(86) PCT No.: PCT/GR2023/000013

§ 371 Date: Oct. 7, 2025

(51) Int. Cl. C10G 47/22; B01J 19/02

(52) U.S. Cl. CPC C10G 47/22; B01J 19/02; B01J 2219/0286; C10G 2300/1037; C10G 2300/4081; C10G 2300/807; C10G 2400/20

(57) ABSTRACT

The present disclosure is concerned with a method of supplying a stream of a liquid hydrocarbon to an inlet of a steam cracking furnace and injecting hydrogen gas into the stream of the liquid hydrocarbon at or before the inlet of the steam cracking furnace to produce a mixture of the liquid hydrocarbon and the hydrogen gas. The liquid hydrocarbon in the mixture undergoes steam cracking to produce a reaction product that includes hydrocarbons having smaller carbon chain lengths than before entering the steam cracking furnace. The method does not comprise hydroprocessing the liquid hydrocarbon before steam cracking.

### FIELD OF DISCLOSURE

Embodiments of the present disclosure are directed towards steam cracking of liquid hydrocarbons and specifically steam cracking of non-hydroprocessed liquid hydrocarbons.

### BACKGROUND

Steam cracking is a process in which heat, sometimes supplemented by high pressure and/or catalysts, is used to break hydrocarbon molecules down into lighter molecules. One source of hydrocarbon molecules for steam cracking is liquid hydrocarbons, such as pyrolysis oil that are derived from plastic waste that has undergone a pyrolysis process. The pyrolysis process is a thermochemical degradation reaction at high temperatures that decomposes plastic waste in the absence of oxygen or a low-oxygen environment to produce pyrolysis oil, gaseous vapor and tar, where the yields of each depend on the pyrolysis technology. The pyrolysis oil produced, however, often contains impurities such as metals, halogens, chlorine, oxygenates, sulfur and nitrogen. These impurities have the potential to poison catalysts and damage the steam cracker. As a result, the impurities need to be removed from the pyrolysis oil before the oil can be utilized in downstream processes (e.g., a steam cracking process).

Impurities in pyrolysis oil can be removed using a variety of techniques. One technique to remove the impurities from pyrolysis oil prior to steam cracking is through hydroprocessing. In hydroprocessing, pyrolysis oil is catalytically processed under an atmosphere of hydrogen at elevated temperatures to help eliminate the impurities. Hydroprocessing also helps to further saturate the hydrocarbons in the pyrolysis oil, which helps the steam process produce more ethylene while also reducing fouling precursors. The use of hydroprocessing, however, requires large capital investment and adds time to the overall processing of pyrolysis oil. As an alternative to such costs, there are other processes that can be used to eliminate the impurities from pyrolysis oil. These other processes, however, lack the ability to improve the desired saturation of the pyrolysis oil. Therefore, there is a need in the art to help both eliminate the impurities in the pyrolysis oil while simultaneously improving the saturation of the hydrocarbon molecules in the pyrolysis oil without requiring the large capital investment of a hydroprocessing system.

### SUMMARY

The present disclosure provides for a method and a system for steam cracking that both helps to eliminate the impurities in liquid hydrocarbons, such as pyrolysis oil, while simultaneously improving the saturation of the liquid hydrocarbons without the large capital investment of a hydroprocessing system for the steam cracking system. To this end, the present disclosure provides for a method of supplying a stream of a liquid hydrocarbon to an inlet of a steam cracking furnace and injecting hydrogen gas into the stream of the liquid hydrocarbon at or before the inlet of the steam cracking furnace to produce a mixture of the liquid hydrocarbon and the hydrogen gas. The liquid hydrocarbon in the mixture undergoes steam cracking to produce a reaction product that includes hydrocarbons having smaller carbon chain lengths than before entering the steam cracking furnace. The method of the present disclosure does not comprise hydroprocessing the liquid hydrocarbon before steam cracking. For the various embodiments, the reaction product includes at least ethylene.

For the various embodiments, the mixture of the liquid hydrocarbon and the hydrogen gas at the inlet includes 0.1 weight percent (wt. %) to 10 wt. % hydrogen gas based on the total weight of the mixture. In an additional embodiment, the mixture includes 5 wt. % to 7 wt. % hydrogen gas based on the total weight of the mixture. In a further embodiment, the mixture includes 0.1 wt. % to 1 wt. % hydrogen gas based on the total weight of the mixture. In a specific embodiment, the mixture includes 6 wt. % hydrogen gas based on the total weight of the mixture.

Advantages of the present method can include as a result of injecting hydrogen gas into the stream of the liquid hydrocarbon the lowering of a heat of reaction in producing the reaction product from the liquid hydrocarbon in a first half of the steam cracking furnace as compared to not injecting hydrogen gas into the stream of the liquid hydrocarbon. For example, the energy absorbed by the process coils may be at least 20% lower than the energy for the equivalent hydrogenated feed. As seen herein, FIG. 5 provides an illustration that adding 3 wt. % H₂ can potentially lead to a 45% energy reduction in the furnace, or a 15% reduction compared to the olefin feed. Further advantages of the present method include both the time and money saved by not hydrotreating the liquid hydrocarbon before undergoing the steam cracking process.

Embodiments of the present disclosure further include separating the reaction product from the steam cracking furnace into at least a first fraction that includes at least hydrogen gas and using the first fraction as at least part of the hydrogen gas that is injected into the stream of the liquid hydrocarbon at or before the inlet of the steam cracking furnace. In one embodiment, the method includes using the first fraction as all of the hydrogen gas that is injected into the stream of the liquid hydrocarbon at or before the inlet of the steam cracking furnace. For the various embodiments, the first fraction can further include at least methane that is injected with the hydrogen gas into the stream of the liquid hydrocarbon at or before the inlet of the steam cracking furnace. Embodiments of the present disclosure can further include separating the reaction product into at least the first fraction and a second fraction, where the second fraction includes olefinic byproducts from the reaction product from steam cracking furnace, and adding the second fraction to the stream of the liquid hydrocarbon and hydrogen gas at or before the inlet of the steam cracking furnace.

The various embodiments can further include removing impurities from the liquid hydrocarbon prior to feeding the mixture to the inlet of the steam cracking furnace. In one embodiment, removing impurities from the liquid hydrocarbon can include extracting impurities from the liquid hydrocarbon in a liquid-liquid extraction process.

Embodiments of the present disclosure further include a cracking furnace system that includes a chemical impurities liquid-liquid extraction rector, a steam cracking furnace and a hydrogen input line to supply hydrogen gas to the inlet of the steam cracking furnace. For the various embodiments, the chemical impurities liquid-liquid extraction rector has a fluid inlet and a fluid outlet. Liquid hydrocarbon having impurities enter the chemical impurities extraction system through the fluid inlet. In the chemical impurities extraction system at least some of the impurities in the liquid hydrocarbon are separated from the liquid hydrocarbon in a liquid-liquid extraction process to produce a reduced impurities liquid hydrocarbon that exits the chemical impurities liquid-liquid extraction rector through the fluid outlet. The steam cracking furnace is coupled to the fluid outlet of the chemical impurities liquid-liquid extraction rector. The reduced impurities liquid hydrocarbon enters the steam cracking furnace at an inlet without having passed through a hydrotreating plant. The hydrogen input line supplies hydrogen gas to the inlet of the steam cracking furnace, where the hydrogen gas mixes with the reduced impurities liquid hydrocarbon entering the steam cracking furnace to produce hydrocarbons having a smaller carbon chain length than before entering the steam cracking furnace. For the various embodiments, the steam cracking furnace includes a furnace preheat section formed from a steel alloy that is resistant to high temperature hydrogen attack. For the various embodiments, the cracking furnace system further includes a steam cracking separation systems connected to the steam cracking furnace, where the steam cracking separation systems receives the hydrocarbons and hydrogen from the steam cracking furnace and separates at least some of the hydrogen (e.g., produces the first fraction) to supply to the inlet of the steam cracking furnace through the hydrogen input line.

### BRIEF DESCRIPTION OF DRAWINGS

FIG. 1 is a schematic diagram of a cracking furnace system according to an embodiment of the present disclosure.

FIG. 2 is a graph illustrating ethylene yield changes from hydrogen gas injected into a liquid hydrocarbons stream according to the present disclosure.

FIG. 3 is a graph illustrating decreases in byproduct production from the injection of hydrogen gas in the olefin feed according to the present disclosure.

FIGS. 4A and 4B are graphs illustrating the reduction in carbon disulfide and thiophene formation from hydrogen gas injection according to the present disclosure.

FIG. 5 is a graph illustrating the heat absorbed in the furnace radiant coils, provided as sensible heat and heat of reaction, according to embodiments of the present disclosure.

FIG. 6 is a schematic diagram of a cracking furnace system according to an embodiment of the present disclosure.

### DETAILED DESCRIPTION

The present disclosure provides for a method and a system for steam cracking liquid hydrocarbons that helps to both eliminate the impurities in liquid hydrocarbons while simultaneously improving the saturation of the liquid hydrocarbons without the need for a hydroprocessing system. To accomplish this, the present disclosure provides for the injection of hydrogen gas at or just prior to the entrance of a steam cracking furnace, where the mixture of the hydrogen gas and the liquid hydrocarbons, as discussed herein, helps to increase the saturation of the liquid hydrocarbons, thereby suppressing reactions that lead to undesirable fouling compounds, and enhancing ethylene production in the steam cracking system.

For the various embodiments, the liquid hydrocarbons do not undergo hydroprocessing, as is known in the art, prior to entering the steam cracking furnace. As used herein, hydroprocessing can include, but are not limited to, hydrotreating and/or hydrocracking as are known in the art. As a result, the present disclosure provides for steam cracking of what are referred to herein as “non-hydroprocessed” liquid hydrocarbons. For brevity, the non-hydroprocessed liquid hydrocarbons of the present disclosure may be referred to simply as “liquid hydrocarbons” or “liquid hydrocarbon” herein. As used herein, liquid hydrocarbons useful for the present disclosure can include, but are not limited to, naphtha, petroleum naphtha, liquified petroleum gas (LPG), gas oil, pyrolysis oil from, for example, the pyrolysis of waster plastics and liquid hydrocarbons derived from other natural sources (e.g., crude oil) or industrial processes that can be cracked to produce, among other compounds, ethylene. Preferably, liquid hydrocarbons useful for the present disclosure include unsaturated hydrocarbons and/or most preferably pyrolysis oil from, for example, the pyrolysis of waster plastics. In addition to liquid hydrocarbons, the present disclosure may also be useful in cracking other hydrocarbons in either a liquid or gaseous state, such as ethane, propane, butanes, pentanes and kerosene, among others known in the art.

As discussed herein, liquid hydrocarbons are known include any number of catalyst fouling impurities such as metals, halogens, chlorine, oxygenates, sulfur and nitrogen, among others. For example, representative pyrolysis oil can easily contain upwards of 350 parts per million (ppm) of chlorine (Cl), 30 ppm of bromine (Br), 15 ppm of calcium (Ca) and 15 ppm of silicon (Si). In an additional example, heteroatom upper limits in naphtha can be as low as 3 ppm for total organic Cl and 10 ppm for total Cl. These impurities have the potential to poison catalysts used in the various processes involved in the steam cracking process along with damaging the steam cracking furnace itself, which is highly undesirable. As a result, the impurities need to be reduced or removed from the liquid hydrocarbons before they can undergo the steam cracking process and/or other downstream processes.

As discussed, the use of a hydroprocessing system can help to provide a reduction in impurities in the liquid hydrocarbons while also improving the saturation of the liquid hydrocarbons. The drawback to the use of a hydroprocessing system, however, is its high cost in terms of both capital expenditure and additional steps that are needed in the steam cracking system (i.e., the increased cost and time necessary for using a hydroprocessing system). Other approaches to reducing heteroatoms in liquid hydrocarbons prior to steam cracking can include chemical extraction processes that use, for example, a hot sodium hydroxide aqueous solution as well as polar solvents (e.g., N-Methyl-2-Pyrrolidone). Such chemical extraction processes, however, do not adequately address the unsaturated components in the liquid hydrocarbons. It is typical for liquid hydrocarbons to include unsaturated hydrocarbons, such as alkenes, dialkenes, and aromatics, which can all contribute to lowering ethylene production and increasing coking and/or fouling of the steam cracking furnace.

As understood, the presence of unsaturated components in liquid hydrocarbons undergoing steam cracking can lead to a decrease in desired products (e.g., ethylene) and an increase in undesired products that can lead to fouling in the steam cracking system. For example, pyrolysis oil derived from pyrolyzed polyethylene can contain over 40 wt. % olefins in the light distillate (e.g., 54-208° C.) and almost 50 wt. % in the middle distillate (e.g., 200-375° C.). An acceptable upper limit for olefins in a steam cracking furnace is, however, typically about 1 vol. %. One reason for this limit is that in the steam cracking oven olefins are known to produce more coke in the radiant coils along with the downstream transfer line heat exchanger (TLE) than the equivalent saturated hydrocarbon. In fact, it is known that coking rates in the first half of the steam cracking furnace coil system can be practically 90% of the coking in the second half of the coil system. This suggests that coking induced by olefins starts at some of the lower temperatures in the steam cracking furnace. Another issue is that steam cracking olefins typically result in lower ethylene yield than the equivalent saturated hydrocarbons. This ethylene yield difference can be attributed to the increased formation of more unsaturated species such as acetylene, propadiene, butadiene, benzene, and styrene.

The present disclosure helps to overcome these shortcomings in the art by providing a method and a system for steam cracking that both helps to eliminate the impurities in liquid hydrocarbons, such as pyrolysis oil, while simultaneously improving the saturation of the liquid hydrocarbons without the large capital investment of a hydroprocessing system for the steam cracking system. To this end, the present disclosure provides for a method of supplying a stream of a liquid hydrocarbon to an inlet of a steam cracking furnace and injecting hydrogen gas into the stream of the liquid hydrocarbon at or before the inlet of the steam cracking furnace to produce a mixture of the liquid hydrocarbon and the hydrogen gas. The liquid hydrocarbon in the mixture undergoes steam cracking to produce a reaction product that includes hydrocarbons having smaller carbon chain lengths than before entering the steam cracking furnace. The method does not comprise hydroprocessing the liquid hydrocarbon before steam cracking. For the various embodiments, the reaction product includes at least ethylene.

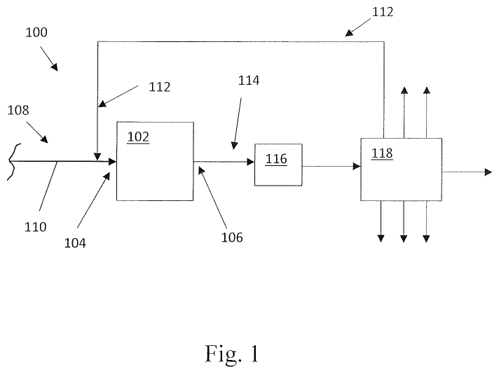

FIG. 1 provides an illustration of an embodiment of a cracking furnace system 100 of the present disclosure. As illustrated, the cracking furnace system 100 includes a steam cracking furnace 102 having an inlet 104 and an outlet 106. A stream 108 of a liquid hydrocarbon is supplied to the inlet 104 of the steam cracking furnace 102 via line 110. As used herein, a “line” can include piping or a conduit that is sufficiently designed and implanted, as is known in the art, to allow for the transport of the material that is being moved between process of the present disclosure.

As illustrated, the stream 108 of the liquid hydrocarbon enters the inlet 104 of the steam cracking furnace 102 without having passed through a hydrotreating plant. In addition, for the various embodiments stream 108 of the liquid hydrocarbon entering the inlet 104 of the steam cracking furnace 102 has not undergone any hydroprocessing steps prior to entering the inlet 104.

The cracking furnace system 100 further includes a hydrogen input line 112 to supply hydrogen to the inlet 104 of the steam cracking furnace 102. For the various embodiments, the hydrogen supplied to the inlet 104 of the steam cracking furnace 102 is in a gaseous state and can be provided as the only gas supplied to the to the inlet 104 of the steam cracking furnace 102 via 110 (e.g., the hydrogen gas is supplied “neat” to the inlet 104). In an alternative embodiment, the hydrogen supplied to the inlet 104 of the steam cracking furnace 102 is part of a gaseous mixture that includes smaller hydrocarbons (e.g., methane in a first fraction as discussed herein).

For the various embodiments, the hydrogen gas from hydrogen input line 112 is injected into stream 108 of the liquid hydrocarbon at or before inlet 104 of the steam cracking furnace 102. In one embodiment, the hydrogen gas from hydrogen input line 112 is injected into stream 108 of the liquid hydrocarbon at inlet 104 of the steam cracking furnace 102. In an alternative embodiment, the hydrogen gas from hydrogen input line 112 is injected into stream 108 of the liquid hydrocarbon before inlet 104 of the steam cracking furnace 102, where there are no processes and/or processing equipment located between where the hydrogen gas from hydrogen input line 112 is injected into the stream 108 of the liquid hydrocarbon and the inlet 104 of the steam cracking furnace 102.

For the various embodiments, the hydrogen gas from hydrogen input line 112 injected into stream 108 of the liquid hydrocarbon produces a mixture of the liquid hydrocarbon and the hydrogen gas. For the various embodiments, the mixture includes 0.1 weight percent (wt. %) to 10 wt. % hydrogen gas based on the total weight of the mixture. In an additional embodiment, the mixture includes 5 wt. % to 7 wt. % hydrogen gas based on the total weight of the mixture. In a further embodiment, the mixture includes 0.1 wt. % to 1 wt. % hydrogen gas based on the total weight of the mixture. In a specific embodiment, the mixture includes 6 wt. % hydrogen gas based on the total weight of the mixture. The mixture of the liquid hydrocarbon and the hydrogen gas enters the steam cracking furnace 102, where under the operating conditions of the steam cracking furnace 102, as discussed herein, the mixture of the liquid hydrocarbon and the hydrogen gas mix with dilution steam to undergo reactions that produce a reaction product that includes hydrocarbons having smaller carbon chain lengths than before entering the steam cracking furnace. For the various embodiments, the dilution steam can have a pressure of 5 to 15 bar gauge (500-1500 Kilopascal) and a temperature from the corresponding saturation level temperature for the given pressure to 200° C. superheated. For the various embodiments, the method of the present disclosure does not comprise hydroprocessing the liquid hydrocarbon before steam cracking. For example, the method does not comprise hydrotreating the liquid hydrocarbon before steam cracking.

For the various embodiments, the compounds in the reaction products include saturated hydrocarbons produced from non-saturated hydrocarbons (e.g., olefinic hydrocarbons) that were initially part of the liquid hydrocarbons entering the steam cracking furnace 102. More specifically, the reaction products can include, for example, hydrogen and C1 to C5 hydrocarbons, where the C1 to C5 hydrocarbons can include, among other compounds, methane, ethylene, propylene, butanes butenes, pentanes and pentenes as are known in the art. For the various embodiments, the reaction product includes at least ethylene. For example, the reaction product stream could include from about 30 to 40 wt. % of ethylene in the reaction product, where the wt. % values are based on the total weight of the reaction product. The reaction products can also include linear, branched and cyclic hydrocarbons, including aromatic hydrocarbons, having carbon numbers of C4 and larger (e.g., C5 and C6).

As is known in the art, the products produced in the reaction depend on several factors, including the composition of the liquid hydrocarbon, on the hydrocarbon to steam ratio and on the cracking temperature and furnace residence time. For the various embodiments, the steam cracking furnace 102, as are known in the art, operate to produce at least ethylene and propylene from the stream 108 of hydrocarbons (e.g., the liquid hydrocarbons 108) and steam. As known in the art, the steam cracking furnace 102 includes two major components, the first of which is a coil bundle where the cracking reactions take place, and the second is a furnace, which supplies the necessary heat to crack the liquid hydrocarbons 108 in the mixture of the present disclosure and steam in the coil bundle. These reactions can take place in the coils located in a radiant section of the steam cracking furnace 102. Temperatures of the steam cracking furnace 102 in this radiant section can range from 700° C. to 950° C., (e.g., 800 to 870° C.) and higher according to the feedstock used. Residence time for the mixture of the present disclosure and steam in the radiant section can be from 1 millisecond to 5 seconds, where the residence time is selected so as to be sufficient to convert the hydrocarbons into the reaction products, which include ethylene and propylene, but not so long to allow production of substantial amounts of coke. Catalysts, as are known in the art, can also be used in the steam cracking furnace 102 to achieve higher conversion rates of the liquid hydrocarbons.

The steam cracking furnace 102 further includes a furnace preheat section of the furnace, that can contain gas-gas heat exchangers, as are known in the art. The gas-gas heat exchangers can be utilized to preheat the steam and the mixture, according to the present disclosure, passing through the coils. This preheating procedure serves to increase the energy efficiency of the process, thus reducing fuel consumption and operating costs. For the various embodiments, the furnace preheat section can be formed from a steel alloy that is resistant to high temperature hydrogen attack. Examples of suitable steel alloys include 304H, 800H, casted 25Cr35Ni.

Once the reaction products leave the steam cracking furnace 102, via the outlet 106, they pass through line 114 to be rapidly quenched in a transfer line exchanger (TLE) 116. The TLE 116, as are known in the art, serves not only to quench the reaction products, but also to recover heat from the reaction products and steam to produce high pressure steam for further use in other process of the cracking furnace system 100 (e.g., driving turbines for compressing the reaction products and operating refrigeration compressors for ethylene and propylene).

The method of the present disclosure further includes separating the reaction product into different fractions for use with the cracking furnace system 100, and in particular the steam cracking furnace 102 of the cracking furnace system 100, as discussed herein. As illustrated in FIG. 1, the reaction products from the TLE 116 enter a steam cracking separation systems 118 connected to the steam cracking furnace 102. The steam cracking separation systems 118 receives the hydrocarbons of the reaction products and hydrogen from the steam cracking furnace 102 and separates at least some of the hydrogen to supply to the inlet 104 of the steam cracking furnace 102 through the hydrogen input line 112.

The steam cracking separation systems 118 can further include a variety of separations units (e.g., distillation units, compressors, coolers and separations towers) as are known in the art for creating fractions of hydrogen and separate hydrocarbon fractions from the reaction products. For example, the steam cracking separation systems 118 can form at least a first fraction that includes at least hydrogen gas present in the reaction products. To accomplish this, the steam cracking separation systems 118 can include a demethanizer unit or tower, as are known in the art, to produce the first fraction that consists of most if not all of the hydrogen and methane present in the reaction products stream. If desired, the overhead stream from the demethanizer tower can be compressed, dried and cryogenically treated to separate the hydrogen from methane, as is known in the art. It is also possible to use a pressure swing absorption (PSA) unit for separation of the hydrogen from the reaction products.

For the various embodiments, the first fraction can be used to supply hydrogen to the hydrogen input line 112. For example, the first fraction can be used as at least part of the hydrogen gas that is injected into the stream 108 of the liquid hydrocarbon at or before the inlet 104 of the steam cracking furnace 102. In one embodiment, the first fraction can be used as all of the hydrogen gas that is injected into the stream 108 of the liquid hydrocarbon at or before the inlet 104 of the steam cracking furnace 102. In an additional embodiment, the first fraction can further include at least methane that is injected with the hydrogen gas into the stream 108 of the liquid hydrocarbon at or before the inlet 104 of the steam cracking furnace 102.

Embodiments of the present disclosure can further include separating the reaction product into at least a second fraction that includes olefinic byproducts from the reaction product from steam cracking furnace. Olefinic byproducts can include C4 and larger olefinic hydrocarbons, including aromatic and non-aromatic olefins. To accomplish this, for example, a bottom stream from the demethanizer unit can be fed to a deethanizer unit or tower as is known in the art. The overhead stream from the deethanizer tower can consist of the C2 products (e.g., ethane and ethylene) from the reaction products. The C2 products can then proceed to a C2 splitter where ethylene can be taken from the overhead of the C2 splitter and ethane coming from the bottom of the C2 splitter can be recycled to the steam cracking furnace 102 as at least a portion of the second fraction to be cracked again. For the various embodiments, the second fraction can be added to the stream of the liquid hydrocarbon and hydrogen gas at or before the inlet of the steam cracking furnace.

For the various embodiments, the bottom stream from the deethanizer unit can go to a depropanizer unit or tower, where the overhead stream from the depropanizer tower consists of the C3 hydrocarbons from the reaction products, which can be processed and split, as is known in the art, into propylene and propane, where the propane can be sent back to the steam cracking furnace 102 for cracking (e.g., as another portion of the second fraction added to the stream of the liquid hydrocarbon and hydrogen gas at or before the inlet of the steam cracking furnace) or for use as fuel. Finally, the bottom stream from the depropanizer unit can be fed to a debutanizer unit, where the overhead stream from the debutanizer includes the C4's from the reaction products. The bottom stream from the debutanizer (light pyrolysis gasoline) consists of the remainder of the reaction products that is C5 or heavier.

Regarding the cracking furnace system and method of the present disclosure, an in-house developed kinetic modelling tool was used to simulate the byproducts formation from steam cracking saturated hydrocarbons versus steam cracking their olefinic counterparts. The kinetic modelling tool was developed based on an initial estimation of the thermodynamic and kinetic rate parameters for the thousands of elementary reactions involved in the steam cracking of hydrocarbons components including ethane, propane, butanes, pentane, hexane and heptane (Wang et al., “'Kinetic Study of Thermal Decomposition of N,N-Diethylhydroxylamine (DEHA) in Steam Crackers”, the 29^{th} Ethylene Producers' Conference, San Antonio, Mar. 27-30, 2017.). Conditions for the simulation included a dilution steam ratio of 0.3; an inlet coil temperature of 630° C.; an outlet coil temperature of 868° C., where the process conditions for the base case (n-hexane) resulted in 31.4 wt. % ethylene (in dry basis). Olefin components are products of steam cracking the above mentioned saturated hydrocarbons, so the model also allowed for simulations of steam cracking of olefin feeds.

Results from the above simulation indicated that the different reaction products could be attributed to the activation energy for dimerization versus the activation energy of cracking. If cyclization or dimerization reactions occur at the heating phase of the reactor, then ethylene yield is suppressed. In addition, processing olefins enhances the formation of side-products at the coldest section of the radiant coil. Therefore, it would be relevant to suppress these reactions and avoid ethylene selectivity losses.

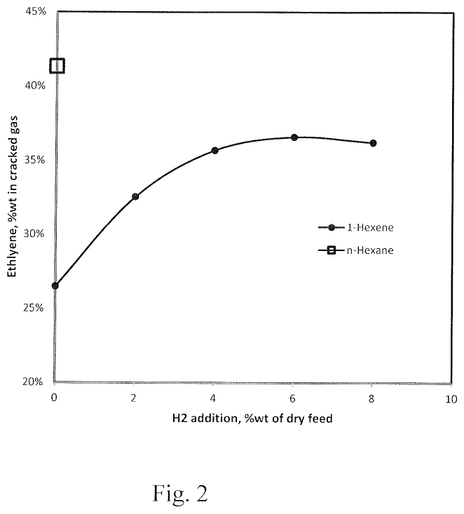

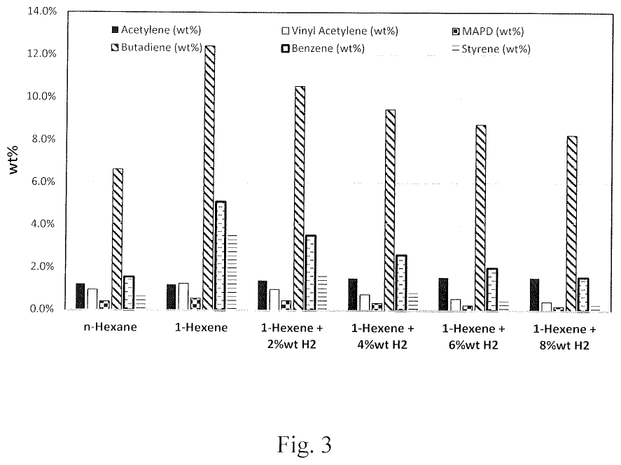

FIG. 2 helps to illustrate that injecting hydrogen gas into the liquid hydrocarbons (e.g., C6) at or before the inlet to the steam cracking oven, as provided herein, helps to increase the yield of ethylene from 26.5 to 36.6%, where the wt. % of hydrogen gas is based on the total weight of the mixture. It was also observed that yield of butadiene also decreased, which may indicate that adding hydrogen gas as provided herein could suppress the production of fouling precursors. Similarly, with the increasing addition of hydrogen gas in the olefin feed, there is decreasing production of other byproducts including acetylene, viny acetylene, methylacetylene and propadiene (MAPD), benzene and styrene, as shown in FIG. 3.

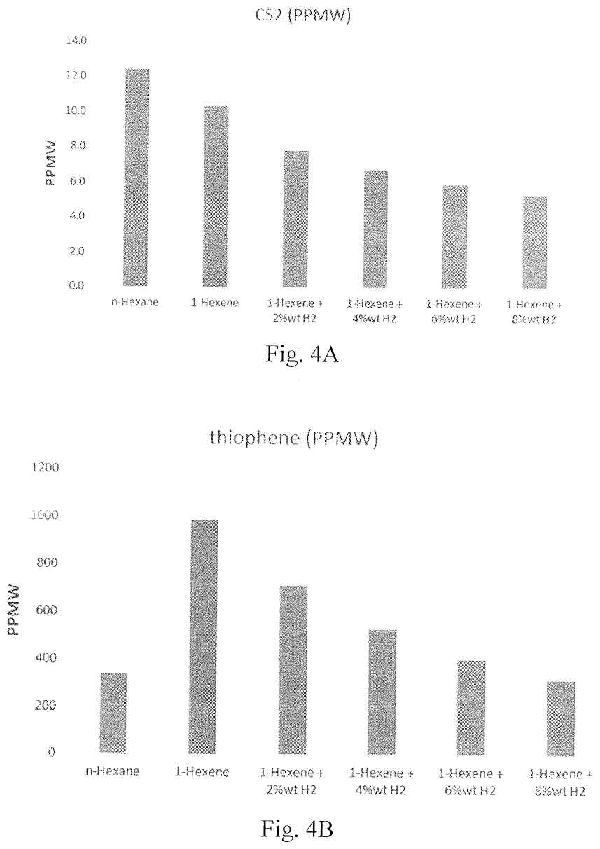

Other benefits of that may be achieved with the present disclosure are that hydrogen addition should suppress the reactions converting dimethyl disulfide to carbon disulfide and thiophene. In further simulations with the above kinetic modelling tool, carbon disulfide and thiophene formation was reduced when hydrogen gas was injected with crude C6 liquid hydrocarbons, where the results are seen in FIGS. 4A and 4B.

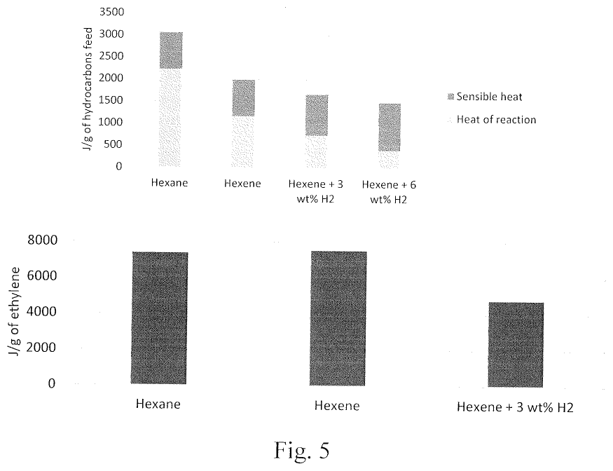

An additional benefit of the present disclosure is that there is relatively less energy required to crack the liquid hydrocarbons when hydrogen is added to form the mixture as discussed herein. Without wishing to be bound by theory, it is believed that the addition of hydrogen as discussed herein inhibits other dehydrogenation reactions and thus reduces the endothermicity of the process. FIG. 5 illustrates this point, where the heat absorbed in the furnace radiant coils is provided as sensible heat and heat of reaction. In addition, injecting hydrogen gas into the stream of the liquid hydrocarbon results in lowering a heat of reaction in producing the reaction product from the liquid hydrocarbon in a first half of the steam cracking furnace as compared to not injecting hydrogen gas into the stream of the liquid hydrocarbon. For example, the energy absorbed by the process coils in the radiant section of the steam cracking furnace will be at least 20% lower than the energy for the equivalent hydrogenated feed. In addition, as seen in FIG. 5 there is an illustration that adding 3 wt. % H₂ can potentially lead to a 45% energy reduction in the furnace, or a 15% reduction compared to the olefin feed.

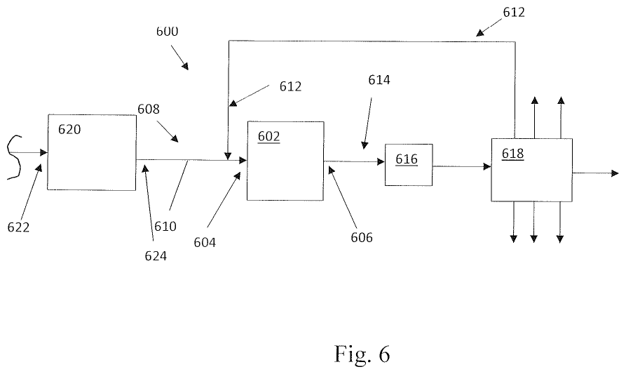

The various embodiments can further include removing impurities from the liquid hydrocarbon prior to feeding the mixture to the inlet of the steam cracking furnace. In one embodiment, removing impurities from the liquid hydrocarbon can include extracting impurities from the liquid hydrocarbon in a liquid-liquid extraction process. For example, referring to FIG. 6, there is shown a cracking furnace system as was illustrated and discussed regarding FIG. 1, the discussion of which is not repeated here but is included by reference to the discussion above, where the cracking furnace system further includes a chemical impurities liquid-liquid extraction rector for removing impurities from the liquid hydrocarbon prior to feeding the mixture to the inlet of the steam cracking furnace. As discussed herein, removing impurities from the liquid hydrocarbon can include extracting impurities from the liquid hydrocarbon in a liquid-liquid extraction process. In addition, it is possible to remove impurities using adsorbents as are known in the art. Other suitable examples of suitable liquid hydrocarbons include, but are not limited to, those formed from polyethylene that has undergo a pyrolysis process, in this case no pretreatment may be required.

As illustrated in FIG. 6, just one example of other possible designs as discussed herein, the cracking furnace system 600 includes a chemical impurities liquid-liquid extraction rector 620 having a fluid inlet 622 and a fluid outlet 624. As discussed herein, liquid hydrocarbon have impurities enter the chemical impurities extraction system 620 through the fluid inlet 622, where at least some of the impurities in the liquid hydrocarbon are separated from the liquid hydrocarbon in a liquid-liquid extraction process to produce a reduced impurities liquid hydrocarbon. The reduced impurities liquid hydrocarbon then exits the chemical impurities liquid-liquid extraction rector 620 through the fluid outlet 624.

For the various embodiments, examples of the chemical impurities liquid-liquid extraction rector 620 can include those found in WO 2022/079057 A1, which is incorporated herein by reference in its entirety. Briefly, the liquid-liquid extraction process is accomplished by contacting the liquid hydrocarbon with an extraction solvent a) which contains one or more heteroatoms and subjecting the liquid hydrocarbon to liquid-liquid extraction with the extraction solvent a), which results in a first stream of the reduced impurities liquid hydrocarbons that exit the chemical impurities liquid-liquid extraction rector 620 through the fluid outlet 624 and a second stream comprising extraction solvent a), heteroatom containing organic compounds; b) mixing at least part of the second stream resulting from step a) with a demixing solvent b) which contains one or more heteroatoms and has a miscibility in heptane which is lower than the miscibility of extraction solvent a) in heptane, and separating the resulting mixture into a first stream comprising heteroatom containing organic compounds and a second stream comprising extraction solvent a) and demixing solvent b); c) contacting at least part of the second stream resulting from step b) with a membrane and recovering a permeate stream comprising demixing solvent b) and a retentate stream comprising extraction solvent a); d) recycling at least part of the extraction solvent a) from the retentate stream resulting from step c) to step a).

For the various embodiments, the extraction solvent a) comprises ammonia or one or more organic solvents selected from the group consisting of diols and triols, including monoethylene glycol (MEG), monopropylene glycol (MPG), any isomer of butanediol and glycerol; glycol ethers, including oligoethylene glycols, including diethylene glycol, triethylene glycol and tetraethylene glycol, and monoalkyl ethers thereof, including diethylene glycol ethyl ether; amides, including N-alkylpyrrolidone, where the alkyl group may contain 1 to 8 or 1 to 3 carbon atoms, including Nmethylpyrrolidone (NMP), formamide and di-and monoalkyl formamides and acetamides, where the alkyl group may contain 1 to 8 or 1 to 3 carbon atoms, including dimethyl formamide (DMF), methyl formamide and dimethyl acetamide; dialkylsulfoxide, where the alkyl group may contain 1 to 8 or 1 to 3 carbon atoms, including dimethylsulfoxide (DMSO); sulfones, including sulfolane; N-formyl morpholine (NFM); furan ring containing components and derivatives thereof, including furfural, 2-methyl-furan, furfuryl alcohol and tetrahydrofurfuryl alcohol; hydroxy esters, including lactates, including methyl and ethyl lactate; trialkyl phosphates, including triethyl phosphate; phenolic compounds, including phenol and guaiacol; benzyl alcoholic compounds, including benzyl alcohol; aminic compounds, including ethylenediamine, monoethanolamine, diethanolamine and triethanolamine; nitrile compounds, including acetonitrile and propionitrile; trioxane compounds, including 1,3,5-trioxane; carbonate compounds, including propylene carbonate and glycerol carbonate; and cycloalkanone compounds, including dihydrolevoglucosenone. For the various embodiments, the demixing solvent b) can comprises one or more solvents selected from the group consisting of water and the solvents from the group of solvents as defined for extraction solvent a).

As seen and discussed with respect to FIG. 1, the steam cracking furnace 602 is coupled to the fluid outlet 624 of the chemical impurities liquid-liquid extraction rector 620. The reduced impurities liquid hydrocarbon enters the steam cracking furnace 602 at the inlet 604 without having passed through a hydrotreating plant or any hydroprocessing process. The cracking furnace system 600 further includes the hydrogen input line 612 to supply hydrogen gas to the inlet 604 of the steam cracking furnace 602. As discussed herein, the hydrogen gas mixes with the reduced impurities liquid hydrocarbon entering the steam cracking furnace 602 to produce hydrocarbons having a smaller carbon chain length than before entering the steam cracking furnace. The reaction products leave the steam cracking furnace 602, via the outlet 606 through line 614 to be rapidly quenched in the TLE 616. The reaction product is then separated into different fractions for use with the cracking furnace system 600, and in particular the steam cracking furnace 602 of the cracking furnace system 600, as discussed herein. As illustrated in FIG. 6, the reaction products from the TLE 616 enter the steam cracking separation systems 618 connected to the steam cracking furnace 602, where the reaction products are separated into the various fractions for use with the present disclosure as discussed above for FIG. 1.

1. A method, comprising:
supplying a stream of a liquid hydrocarbon to an inlet of a steam cracking furnace;
injecting hydrogen gas into the stream of the liquid hydrocarbon at or before the inlet of the steam cracking furnace to produce a mixture of the liquid hydrocarbon and the hydrogen gas; and
steam cracking the liquid hydrocarbon in the mixture to produce a reaction product that includes hydrocarbons having smaller carbon chain lengths than before entering the steam cracking furnace;
wherein the method does not comprise hydroprocessing the liquid hydrocarbon before steam cracking.

2. The method of claim 1, wherein the mixture includes 0.1 weight percent (wt. %) to 10 wt. % hydrogen gas based on the total weight of the mixture.

3. The method of claim 1, wherein the mixture includes 0.1 wt. % to 1 wt. % hydrogen gas based on the total weight of the mixture.

4. The method of claim 1, wherein injecting hydrogen gas into the stream of the liquid hydrocarbon results in lowering a heat of reaction in producing the reaction product from the liquid hydrocarbon in a first half of the steam cracking furnace as compared to not injecting hydrogen gas into the stream of the liquid hydrocarbon.

5. The method of claim 1, wherein the method does not comprise hydrotreating the liquid hydrocarbon before steam cracking.

6. The method of claim 1, further including separating the reaction product into at least a first fraction that includes at least hydrogen gas; and
using the first fraction as at least part of the hydrogen gas that is injected into the stream of the liquid hydrocarbon at or before the inlet of the steam cracking furnace.

7. The method of claim 6, further including using the first fraction as all of the hydrogen gas that is injected into the stream of the liquid hydrocarbon at or before the inlet of the steam cracking furnace.

8. The method of claim 1, wherein the first fraction further includes at least methane that is injected with the hydrogen gas into the stream of the liquid hydrocarbon at or before the inlet of the steam cracking furnace.

9. The method of claim 1, further including separating the reaction product into at least a second fraction that includes olefinic byproducts from the reaction product from steam cracking furnace; and
adding the second fraction to the stream of the liquid hydrocarbon and hydrogen gas at or before the inlet of the steam cracking furnace.

10. The method of claim 1, further including removing impurities from the liquid hydrocarbon prior to feeding the mixture to the inlet of the steam cracking furnace.

11. The method of claim 10, wherein removing impurities from the liquid hydrocarbon includes extracting impurities from the liquid hydrocarbon in a liquid-liquid extraction process.

12. The method of claim 1, wherein the reaction product includes at least ethylene.

13. A cracking furnace system, comprising:
a chemical impurities liquid-liquid extraction system having a fluid inlet and a fluid outlet, wherein liquid hydrocarbon having impurities enters the chemical impurities extraction system through the fluid inlet and at least some of the impurities in the liquid hydrocarbon are separated from the liquid hydrocarbon in a liquid-liquid extraction process to produce a reduced impurities liquid hydrocarbon that exits the chemical impurities liquid-liquid extraction rector through the fluid outlet;
a steam cracking furnace coupled to the fluid outlet of the chemical impurities liquid-liquid extraction rector, wherein the reduced impurities liquid hydrocarbon enters the steam cracking furnace at an inlet without having passed through a hydrotreating plant; and
a hydrogen input line to supply hydrogen gas to the inlet of the steam cracking furnace, wherein the hydrogen gas mixes with the reduced impurities liquid hydrocarbon entering the steam cracking furnace to produce hydrocarbons having a smaller carbon chain length than before entering the steam cracking furnace.

14. The cracking furnace system of claim 13, wherein the steam cracking furnace includes a furnace preheat section formed from a steel alloy that is resistant to high temperature hydrogen attack.

15. The system of claim 13, further including a steam cracking separation system connected to the steam cracking furnace, wherein the steam cracking separation system receives the hydrocarbons and hydrogen from the steam cracking furnace and separates at least some of the hydrogen to supply to the inlet of the steam cracking furnace through the hydrogen input line.
